(19) United States
(12) Patent Application Publication
(10) Pub. No.: US 2014/0027576 A1
(43) Pub. Date: Jan. 30, 2014

(54) Earth Observation Constellation Methodology & Applications

(71) Applicants: Christopher Boshuizen, San Francisco, CA (US); William Marshall, San Francisco, CA (US); James Mason, San Francisco, CA (US); Robert Schingler, JR., San Francisco, CA (US)

(72) Inventors: Christopher Boshuizen, San Francisco, CA (US); William Marshall, San Francisco, CA (US); James Mason, San Francisco, CA (US); Robert Schingler, JR., San Francisco, CA (US)

(73) Assignee: Planet Labs Inc., San Francisco, CA (US)

(21) Appl. No.: 13/949,861

(22) Filed: Jul. 24, 2013

Related U.S. Application Data
(60) Provisional application No. 61/675,730, filed on Jul. 25, 2012.

(51) Int. Cl. B64G 1/10

(52) U.S. Cl. CPC B64G 1/1085
USPC 244/158.6

(57) ABSTRACT

The focus of this invention pertains to the methodology behind launching line-scanning satellite constellations that can image an entire planet such as the Earth at high temporal cadence (less than a week), at high spatial resolution (less than 10 m). Utilizing simple control and operation, our invention captures images of an entire planet in an effective and distributed manner. Additional benefits are realized by taking advantage of the distributed onboard storage and computing abilities of such a constellation to optimize the data collected, system latency, and data downlinked.

### DESCRIPTION OF RELATED ART

A list of prior patents, publications, and websites, which may be of interest, is provided below:

| Patent Number | Inventor | Issue Date |
|---|---|---|
| 4,313,678 | Colvocoresses | Feb. 2, 1982 |
| 4,415,759 | Copeland et al | Nov. 15, 1983 |
| 5,596,494 | Kuo | Jan. 21, 1997 |
| 5,911,389 | Drake | Jun. 15, 1999 |
| 5,961,077 | Koppel et al | Oct. 5, 1999 |
| 6,241,192 | Kondo et al | Jun. 5, 2001 |
| 6,257,526 | Taormina et al | Jul. 10, 2001 |
| 6,393,927 | Biggs et al | May 28, 2002 |
| 6,491,257 | Emmons et al | Dec. 10, 2002 |
| 6,502,790 | Murphy et al | Jan. 7, 2003 |
| 6,556,808 | De La Chappelle et al | Apr. 29, 2003 |
| 2010/0311417 | Korb et al | Dec. 9, 2010 |
| 2011/0188548 | Antikidis | Aug. 4, 2011 |

http://www.satimagingcorp.com/gallery.html
www.cosmiac.org.

However the prior art neither addresses nor claims the necessary abilities to implement such a solution for acquisition of high-resolution spatial imaging of planetary bodies with disposable satellite technology.

### BACKGROUND

Artificial orbital satellite technology has been around since 1957 with the launch of Sputnik. The largest Earth-observation satellite constellation as of July 2013 contained 6 satellites (Disaster Monitoring Constellation). The ability to rapidly iterate on expansive, yet inexpensive, satellite constellations has yet to be realized—single commercial earth observing satellites have had costs in the range of $25 m to $1,000 m. Current earth observing satellites provided spatial imaging resolutions in the range of 0.4-30 meters.

Sun-synchronous orbit (SSO) is an orbit fixed relative to the sun with the property that over large timescales (months or years) the orbit does not precess relative to the sun-Earth vector. Thus, spacecraft in this orbit will see the Earth rotating under them relative to the Sun. With a typical orbit being of order 90 minutes in period, from one orbit to another, a given point on the Earth will have rotated 90 minutes to the East, or approximately 1.5 hours of longitude.

### SUMMARY OF THE INVENTION

This application incorporates by technical reference its predecessor provisional application, 61/675,730, as content for consideration in the understanding of the specification. We have developed a methodology and system for creating coherent constellations in space of orbiting elements. Central to the scheme is the concept of having massively distributed satellite systems (wherein each orbital element may be smaller, simpler and/or less expensive than current commercial satellites) and insertion of one or more elements into one or more orbits where in aggregate the elements and combination of orbits provide complete coverage in time and space (location) of an object.

Our invention is capable of being deployed around planetary bodies in space and operating in such a manner to provide uninterrupted data on said bodies for continuous monitoring and examination. Data may be downlinked on a demand-driven basis, given sufficient on-board storage.

One benefit of such constellations is the ability to build redundancy into the number of satellites launched, in addition to the internal systems of each satellite. In addition, by having different subsets of satellites with different sensors, a hyper-sensored constellation can be composed of multi-sensored satellites, or a multi-sensored constellation can be built composed only of single-sensored satellites.

### Spacecraft Elements in a Single Sun-Synchronous Orbit

A number of observation satellites are placed into a single sun-synchronous orbit (SSO) such that the entire object can be sensed every rotation period of that planet.

The innovation is the design of a satellite constellation for continuous monitoring of a planetary body. Consider a string of satellites evenly spaced along track in a single sun-synchronous orbit (SSO) plane. The width of the field of view orthogonal to the velocity vector is defined by the properties and state of the sensing or imaging system, the altitude above the planet' surface, the position and orientation of the satellite and its sensor(s) relative to the planet, and the radius of the planet. One can set the number of satellites, N, to be equal to the orbital period P_{orb}(s) divided by the time it takes the planet to rotate by the satellite's field-of-view width, W(m), at the equator.

Explicitly then:

N>=P_{orb}*W/v,

where v is the velocity of the planet's surface at the equator (m/s). By doing this, once one satellite has taken an image at the equator, then by the time the planet has rotated by the width of that satellite's image, then the next satellite will be passing over and take the next image. If the satellites continuously take images along the velocity vector, such a constellation is able to image every point on the planet once per rotation period of that planet.

For example, if one's satellites have a field-of-view width of 2 degrees and one chose a Sun Synchronous Earth orbit of altitude 400 km then one can calculate the number of satellites needed to line scan: the field-of-view is 20 km across and it takes the Earth 1 minute to rotate 20 km at the equator; the orbital period is 90 minutes and thus one needs 90 satellites with this field-of-view in order to line scan the Earth from this orbital altitude. Further, with any fewer satellites, the constellation will gracefully degrade in repetition rate.

### Spacecraft Elements of a Multi-Unit Architecture

Traditional spacecraft are designed for very long lifetimes through internal system redundancy, or engineering to prevent failure of internal systems. Our invention embodies an additional approach, which is redundancy on the spacecraft level. Spacecraft elements can be short- or long-lived (disposable or not) and when one fails, another replaces it. This can be either achieved by initially deploying more spacecraft than are needed (having on-orbit spares), by rapidly deploying replacements, or by frequently replacing the entire constellation, disposing of the previous generation of elements as their number of functioning units decreases below a useable threshold. Intrinsic to this invention is the superior low cost of our spacecraft elements, without which this scheme would be impractical due to the massive cost required. Much of the savings can be achieved through our methodology of construction and use of readily available off-the-shelf electronics and materials given the mass introduction of various space-ready materials in the general consumer marketplace.

In the case of launching multiple spacecraft, the number to be launched can be calculated, such that given the expected failure rate of each individual element, the mission length for which 100% of capability is expected to be achieved can be extended. For example, if 80% of orbital elements are expected to fail within an intended 2-year operational lifetime, 125% of the minimum necessary spacecraft elements can be launched, such that over two years, the expected capability is 100%. For a desired constellation size of 100 satellites, and 80% survival probability, 129 would have to be launched to have greater than a 70% probability that 100 satellites survive, or 137 for a 95% probability. This relationship between the probability, y, that at least a certain number of satellites, x, will be operational can be expressed as a cumulative distribution function with the probability, p, that each satellite independently survives, and n the number of satellites initially launched, such that

$$y = {\sum }_{i = x}^{n} ( \begin{matrix}n \\ i\end{matrix} ) {{p}^{i} ( 1 - p )}^{n - i}$$

Our invention embodies these concepts as a way of managing a spacecraft fleet to guarantee an intended level of reliability over a necessary operational timeframe. In addition, it enables recognizing and achieving a greater return on investment through the commoditization of the plethora of space elements-based constructed systems.

### Whole Earth Imaging

This invention allows for sensing of the entire Earth or other planetary body simultaneously by inserting the appropriate number of spacecraft into the right number of orbital planes. To provide 5 m resolution once per minute of the entire Earth's surface, 1440 orbital planes at 400-600 km altitude, containing 90-100 spacecraft with a 10 cm optical aperture would suffice. Various congruent solutions can be found by changing these parameters. For instance, increasing the field of view of the instrument by a factor of 10 would necessitate only 144 orbital planes with 10 spacecraft per orbit.

### Various Types of Applications With the Use of the Technology Developed

### Earth and Other Planetary Bodies Imaging

Earth imaging has been described extensively above. The revisit rate at a given point on the ground and the resolution can be optimized through careful selection of key parameters, such as the field of view of the imaging instrument, resolution of the instrument, altitude of the orbit, number of spacecraft, satellite and sensor orientation, orbital period, and spacecraft spacing. However this network of space elements could feasibly be configured and utilized to image other planetary bodies in space from moons, planetoids, planets, and asteroids to solar systems, stars, black holes, nebulas and other objects to be remotely sensed.

### Whole Sky Imaging

Just as spacecraft elements in this invention can be turned inwards towards Earth, they can also be pointed away from Earth, and used for a variety of other applications, which we detail here, as briefly mentioned earlier in our specification and also below.

### Debris

Debris in space can be monitored by a constellation of spaceward- or horizon-pointing spacecraft. The considerations for spacecraft orbits and density are similar to those above. Optical imagers and near-infrared sensors are most useful for detecting debris. Long exposure times allow debris to be seen as streaks against the background of space. Large numbers of spacecraft allow the entire sky to be imaged at once, and the simplification of the design of each node, each of which thus no longer need to move and track debris.

### Ground-Based Communications Including Internet

Just as the invention allows comprehensive coverage of the ground for imaging purposes, the invention allows the transmission of data to and from the spacecraft elements to be all-persistent, which is ideal for applications requiring high areal coverage, such as Internet and other communications transmissions, all of which occur in a real-time or delayed time setting format based on the needs and/or preparation for potential conditions. Said information of data is transmitted via a ground station as part of the communication scheme to the orbiting elements.

### Space-Based, Including Interplanetary Relays, Lunar-Orbiting Communications

By extension, beyond Earth orbit the scheme also allows the creation of chains of spacecraft elements, whereby messages can be passed along the chain. Therefore, the problems of weak radio links at large distances from the earth can be mitigated through the use of communications relay hubs.

### Near Earth Objects

Near Earth Objects (NEOs) are asteroids, meteors and the like, which cross or pass near the Earth's orbit. The invention here can be used to track and characterize NEOs through persistent, whole-sky imaging.

### Other Astronomical Events

Supernovae are rapidly occurring astronomical events that require continuous monitoring. Considerable resources are spent looking for them, but only after detection can be they be studied in detail. The invention here allows the continuous monitoring for, and unbroken recording of, supernovae and similar astronomical events.

### Multi-Unit Space Architecture

By placing multiple spacecraft in the same SSO orbit, it is possible to reduce equatorial-crossing time shift, as described in the background, to an arbitrary level. For instance, with 90 spacecraft in 90-minute orbits, the Earth will. have rotated to the east by 1 minute between satellite crossings. If the field of view of the instruments onboard the spacecraft is equal in width to the distance the Earth has rotated in that time (27.8 km at the equator, in the case of 1 minute separation) then the instruments in aggregate will be able to image the entirety of Earth, with increasing overlap towards the poles due to the spherical nature of the Earth.

In the case of an Earth-imaging system, the optical instrument could either take separate image frames with an appropriate spacing, or continuous video. The result is then the complete recording of a band of latitude by the entire constellation in one given instance, or of the recording of a sinusoidal ground track by a single spacecraft, that returns to the same latitude every 90 minutes, and the same location on the Earth every day.

### Multiple Equatorial Times for Time of Day Images

Inserting spacecraft into orbits with differing equatorial crossing times enables imaging an object at different times of day. We claim here a means of providing simultaneous coverage of bands of latitude with the addition of more spacecraft in any number of evenly or otherwise spaced apart SSO orbits. We claim here also a means of imaging a band of fixed latitude by inserting one spacecraft into each of many SSO orbits, such that the spacecraft ascend and descend around the Earth in unison. With appropriate matching of their field of view in regard to their orbital spacing, it is possible to create a line scanner that is the transpose of the one depicted in FIG. 1.

### Ability to Do Coarse Image Differencing on Orbit and Thereby Reduce Data Downlink

As each element in an orbit traces out a sinusoidal path around the planetary object, this stripe of data can be compared against a pre-recorded reference map, and the difference taken between the two at a pixel or individual data point level. In this way, it is possible to reduce the amount of data that needs to be downlinked to the ground by a very large factor. With Huffman coding or a similar lossless compression method, the expected image can be used as a prior for improved compression.

### Ability to Detect Change on Orbit Using Image Differencing

As above, the difference can be taken between a recent and an older dataset on board the spacecraft element. In this way, change can be detected in orbit. Extending the idea of image differencing the nature of the difference can be determined, and its mere existence can be communicated to the ground, or cause additional image taking onboard. This invention results in a drastically reduced downlink data rate, and the ability to create a responsive early warning system for global change.

Ability to Create Hyper-Sensored Constellation with Multi-Sensored Elements

A constellation of many elements can be designed with more types of measuring instruments than can be contained in any single element, at the coverage frequency desired. For example, in the case of imaging satellites, each satellite could measure a single spectrum, with the entire constellation imaging in many spectra. Alternatively, each satellite could measure multiple spectra, with the entire constellation imaging in many more spectra than any individual element independently. With other sensors and elements, the case is analogous. Depending upon the number of elements chosen, the constellation can be designed to image the entire earth every imaging period in each spectra or with each sensor, or pieced together over multiple imaging periods.

For a single satellite in polar orbit, the absolute minimum number of orbits to sense the entire planet's surface is its circumference (C) divided by each satellite's sensing swath width (W), non-dimensionalized to 1/w.

n_{abs-in-single=C/W=1/w}

For m satellites in distinct polar orbits, the absolute minimum orbits to sense the entire surface of a roughly spherical planet is its circumference divided by each satellite's sensing swath width, divided by m.

n_{abs-min-multiple=1/wm}

However, this assumes that each satellite sees each equatorial point exactly once before returning to its original position. For a single satellite, the number of cycles (n) to revisit the same original site must satisfy,

n x_{shift}=k C±δW

where k is some integer, x_{shift} is circumferential distance between equatorial crossings on sequential orbits, and δW allowable equatorial distance error in considering two passes a “revisit,” which is the same as,

nᵣₑᵥᵢₛᵢₜ(k)=(k±δ)s

where s is the fraction of planetary circumference between equatorial crossings on sequential orbits, and δ is the fraction of planetary circumference of allowable error.

In order to guarantee that the satellite sees every point on the planetary body, the portions imaged in each orbit are predicted, summed, and checked to have covered everywhere.

$${n}_{full \text{-} coverage \text{-} single} = {min s . t .}_{p} ( ( min over [ 0 , 1 - \frac{w}{2} ] of {\sum }_{l = 0}^{p - 1} rect ( \frac{t}{w} + ( ls ) \%1 ) ) \geq )$$

w can be substituted with w−2d, where d is the desired minimum swath overlap at the equator.

The analogous formula for m satellites is:

$${n}_{full \text{-} coverage \text{-} multiple} = {min s . t .}_{p} ( ( min over [ 0 , 1 - \frac{w}{2} ] of {\sum }_{k = 0}^{m} {\sum }_{l = 0}^{p - 1} rect ( \frac{t}{w} + ( {x}_{{0}_{k}} + ls ) \%1 ) ) \geq )$$

where x₀_{ₖ} is the starting equatorial position of the k^{th} satellite as a fraction of the planetary circumference, and x₀_{ₒ} is defined as 0. It is assumed that each satellite has the same swath width.

For the minimum time for a single satellite to cover an entire planet in polar orbit,

n=n_{full-coverage-single}>n_{abs-min-single}

and analogous for multiple satellites.

For the minimum time for a single satellite to cover an entire planet in polar orbit and return to its original position,

n=nᵣₑᵥᵢₛᵢₜ(k)>n_{full-coverage-single}>n_{min-single}, ^{k}^{ₑ}^{Z+}

and analogous for multiple satellites.

Thus, depending upon the desired whole-planet-coverage frequency for each spectra or sensor used, a constellation can be designed with variable sensing rates for each spectra/sensor by modifying how many satellites have each sensing ability, and the relative phases between them, taking into consideration that a single satellite may have multiple sensors up to some maximum.

### Five×51.6 Deg

Extending the invention to orbits other than SSO, it is possible to create highly tunable spacecraft architectures, with a range of ground location repeat rates, spatial resolutions, and location coverage maps. For instance, we have invented an orbital concept involving spacecraft in orbits of 45, 51.6, 52 degrees and higher inclinations. Unlike SSO these orbits precess around the Earth at difference timescales, typically 16 days for a full precessing in the examples given. To mimic the same-location repeat characteristic of the SSO orbit, one can add additional orbits. Another characteristic of non-SSO orbits is their ground tracks trace out paths that roll off at high and low latitudes, and so it is possible to increase coverage of regions of interest through appropriate choices of inclination.

### BRIEF DESCRIPTION OF DRAWINGS

FIG. 1 is a schematic of a typical satellite constellation

FIG. 2A is a schematic of the satellite constellation in a single orbital plane with equal coverage for all of the sensors.

FIG. 2B is a schematic of the satellite constellation in a single orbital plane with non-equal coverage between the sensors employed.

FIG. 3 is a schematic of the satellite constellation in multiple orbital planes.

### TECHNICAL DETAILED DESCRIPTION OF THE INVENTION

### Best Mode And Preferred Embodiment

The following detailed description is of the best currently contemplated modes of carrying out the invention. The description is not to be taken in a limiting sense, but is made merely for the purpose of illustrating the general principles of the invention, since the scope of the invention is best defined by the appended claims.

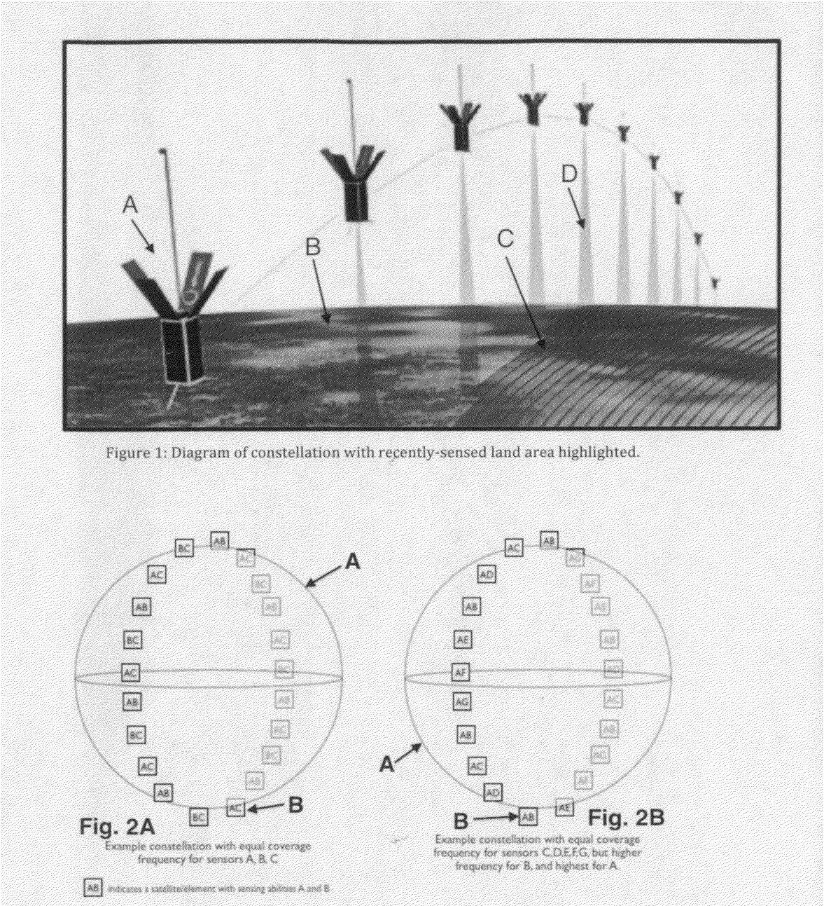

The business method described is to launch a constellation of relatively small, as depicted in FIG. 1, orbiting spacecraft elements (“elements,” “satellite”) that may be satellites, sensor nodes, buoys, or other instrumented platforms A, into a pre-designed constellation, such that the elements in congregate cover the entire or majority of the Earth, or other planetary body (“object,” “planet”) B on a frequent revisit rate or daily with imaging, instrumentation, measuring or sensing capability frequency beams (“sensing,” “sensors,” “sensed data”) C that do so in a parallel track manner D. Due to the multi-element design, element redundancy can be built into the system, and variety in types of elements A and their sensors C can together create distributed sensor networks, with more types of sensors C than any one element A could alone contain and support.

With daily or high frequency whole-object sensing, change detection can be applied to sequential and non-sequential measurements. Anomalies can lead to alerts, and data can be fed towards customers, products, predictive models, and all other entities using the data (“end-users”).

We have developed a methodology and system for creating coherent constellations in space of orbiting elements as depicted in FIG. 1. Central to the scheme is the insertion of one or more elements into one or more, where in aggregate the elements A and combination of orbits provide complete coverage in time and space (location) of an object.

As depicted in FIGS. 2A and 2B, when launched on a single launch vehicle, a large number of elements (FIG. 2A-B or FIG. 2B-B) might be deployed along a single orbital track, with a random or controlled spacing along the orbital track, providing spatial separation and hence spatial coverage of the ground or outer space. When placed into a sun-synchronous orbit (SSO) A, a chain of spacecraft elements (FIG. 2A-B or FIG. 2B-B) can be constructed such that the entire object's surface can be sensed once a day. Multiple sun-synchronous orbits can be used to increase the repeat time for whole-object sensing beyond once per day.

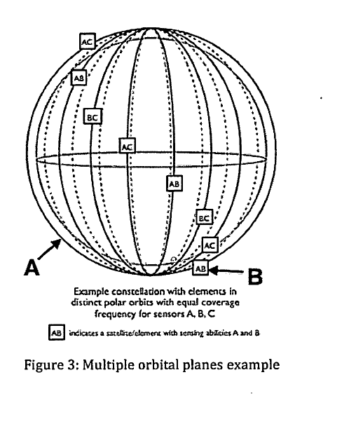

As depicted in FIG. 3, placement of spacecraft elements B into non-SSO orbits A can be used to create dynamic constellations of varying coverage, resolution and repeat rate. The key factors of a multi-unit space architecture are the breadth of coverage of the instruments in question (field of view of an optical telescope, or similar analogues), the number of elements B in the architecture, their spacing or orbital density, the number of orbital planes, and the orbital parameters of these orbital planes through an X, Y, Z coordinate map system which works with a forward flight axis, a cross track axis, and a vertical axis. The orbital decay lifetime of the spacecraft is also an important parameter.

Demand-Driven Download from Spacecraft Elements

The spacecraft elements, rather than uniformly sending down all sensed data sequentially all of the time, can instead have a demand-driven system, in which signals are sent to the spacecraft element, indicating which data should be treated as high-priority. Based on customer demand, important events, onboard detection algorithms (either developed by the Company or by its customers), etc., prioritized data can be the first sent to ground stations or through other communication channels. Customers can sign up for alerts for certain events and be given access to the imagery based on the thresholds they set.

### Change Detection on Daily Updates

Onboard difference calculations between just-sensed data and previously-sensed data can be used to create early warning systems in the case of drastic change or other notable anomalies. Change detection can also be used in order to compress images—only the differences in images from one day to another need be saved and transmitted, once a baseline is established.

Once images are accessed and downloaded from the satellite or element, further analysis can occur. Change detection between daily updates can provide insight into how environments, human-made systems, weather, etc. change day-to-day, and then in aggregate, week-to-week, month-to-month, and at any other timescale. Having this easily available day-by-day enables fast feedback and response to changing conditions worldwide.

### CONCLUSION

The present invention has been described in an illustrative manner. It is to be understood that the terminology that has been used is intended to be in the nature of words of description rather than of limitation. While there have been described herein what are considered to be preferred and exemplary embodiments of the present invention, other modifications'of the invention shall be apparent to those skilled in the art from the teachings herein and it is therefore desired to be secured in the appended claims all such modifications as fall within the true spirit and scope of the invention.

Accordingly what is desired to be secured by Letters Patent of the United States is the invention as defined and differentiated in the following claims.

1. A system for use in spatial imaging of planetary bodies through a series of steps comprising;
a) implementation into space a network of, ranging from a singular to plural, constellation of orbital elements;
b) enabling said constellation of orbital elements, through an algorithmic calculated means, to jointly achieve a desired revisit rate and spatial coverage;
c) controlling said constellation through a remote transmission means;

2. The system of claim 2 wherein said orbital element is positioned in dynamic position relative to of said planetary body in such a manner that its sensor(s) may collect data through a computational means, regarding the planetary body it orbits

3. The system of claim 1 wherein there is further included the step of acquiring the sensed data and the absolute geophysical coordinates simultaneously.

4. The system of claim 1 wherein additional orbital elements are initially included in, or later added to, the constellation configuration to enhance system redundancy and performance.

5. The system of claim 1 wherein all or some of the orbital elements have the on-board ability to take the difference between their sensed data and previous data and/or create a new dataset from computed from data including that collected.

6. The system of claim 5 wherein the difference between new and prior sensed data is used to further compress the data downlinked to the ground.

7. A system of claim 5 wherein the difference between new and prior sensed data is used to effect in some way an onboard process, such as data collection, data storage, or downlinking.

8. A system of claim 1 wherein the total number of types of sensors in the constellation exceeds the number of types of sensors on any one given orbital element.

9. A system of claim 1 wherein all or some of the orbital elements have onboard storage, where sensed data is stored for a period of time, and then the downlink priority is at least partially determined by data later uplinked to the orbital elements.

10. The system of claim 9 wherein the orbital elements downlink downsampled data, compressed data, or metadata to assist in the determination of the downlink priority.
